(19) United States
(12) Patent Application Publication
(10) Pub. No.: US 2010/0030662 A1
(43) Pub. Date: Feb. 4, 2010

(54) SYSTEM AND METHOD FOR PLACING ORDERS VIA THE INTERNET

(76) Inventor: Steffan Gottfried Klein, Victoria (AU)

Correspondence Address: Pearl Cohen Zedek Latzer, LLP, 1500 Broadway, 12th Floor, New York, NY, 10036, US

(21) Appl. No.: 12/374,533

(22) PCT Filed: Jun. 26, 2007
(86) PCT No.: PCT/AU2007/000884

§ 371 Date: Aug. 19, 2009

(30) Foreign Application Priority Data
Jul. 21, 2006 (AU) 2006903952
Oct. 30, 2006 (AU) 2006100925

(51) Int. Cl. G06Q 30/00; G06F 15/173

(52) U.S. Cl. 705/27; 709/226

(57) ABSTRACT

A system (100) enables a customer (103) to order goods via the Internet using a browsing device (104). The system includes at least one web server (106). The system further includes at least one DNS server (105) within a DNS system, which is configured to establish an association between goods (107), at least one corresponding domain name (102), and the web server (106). A request issued to the DNS server (105) to resolve the domain name (102) results in a response providing an Internet address of the web server (106). The web server (106) is configured to respond to a connection request initiated using the Internet address and a corresponding network resource locator including the domain name (102) by executing an ordering process. In various embodiments, the network resource locator may include a product identifier within the domain name, or within a distinct component thereof. The ordering process may proceed directly and automatically to the final placement of an order on behalf of the customer (103), or may include a check-out process prior to the final placement of an order.

### FIELD OF THE INVENTION

The present invention relates to electronic commerce and in particular to an improved system and method which enable the initiation and completion of a buying process via the Internet.

### BACKGROUND OF THE INVENTION

Buying one or more physical or digital products and services (goods) via the Internet has become commonplace today. To take part in e-Commerce, according to a common process, customers visit websites, locate products and then click on Buy Now or Add-to-Cart buttons which are embedded on web pages to initiate the purchasing process.

However this approach of buying via the Internet does not lend itself to the promotion of items and services on TV, radio, magazines, newspapers or other media (Offline World) where the customer is required to make the actual purchase via the Internet, and where the marketing is designed to initiate impulse buying by a potential customer.

For example many TV or radio advertisements are geared towards initiating impulse buying among potential customers—their content is designed to get customers to call a phone number to order a promoted product immediately. The reasoning behind this approach is to minimize the steps a customer has to take after deciding to buy, to maintain their buying impulse.

The Internet does not currently support a purchasing method as directly as calling a phone number and placing an order.

To purchase a product via the Internet, a customer must first enter a domain name to go to the website of a seller. Then he must navigate to or search for a page containing the promoted product and then click on at least one button embedded on the product page to initiate the purchase of the product.

The several steps required by this process risk extinguishing the buying impulse. Furthermore customers may be distracted by the website itself or by other products on the website. Even if the very first page which is displayed when the domain name is entered lists only one product, customers still have to locate a Buy Now or Add to Cart button embedded on the page and must then click on it to initiate the purchasing process.

A method or system which removes these steps and which makes an impulse purchase via the Internet for products promoted in the Offline World as easy as placing a phone call is therefore regarded as highly desirable.

A prior art method which may assist to boost impulse buying via the Internet is described in U.S. Pat. No. 5,960,411, dated 28 Sep. 1999 and assigned to Amazon.com, Inc. However, the system and method disclosed therein only addresses the purchasing process after the customer has navigated with his browsing device (Client System) to the appropriate webpage which contains the Buy Now button. And it still requires a customer to take an action such as clicking on a button.

U.S. Pat. No. 5,960,411 therefore does not address the problem of maintaining the buying impulse of a customer who has been attracted by promotional or other information provided in the Offline World.

The only method currently available to sellers to entice customers to complete a purchase for a product advertised in the Offline World is to advertise their domain name in the Offline World to get customers to visit their web site. Customers must then be encouraged to navigate to a product and to take an action to initiate a purchasing process such as clicking with a mouse on a Buy Now or Add-to-Cart button (Buy Buttons).

This is because these Buy Buttons—which are currently required to initiate a purchase—do not lend themselves for promotion in the Offline World.

There are two general types of Buy Buttons in use today.

TYPE ONE Buy Buttons rely on programming code such as a Form element being embedded on a web page to perform their function.

A TYPE ONE example is the PayPal Buy Now button:

<form action=“https://www.paypal.com/cgi-bin/webscr” method=“post”>
<input type=“hidden” name=“cmd” value=“_xclick”>
<input type=“hidden” name=“business”
value=“registrations3@3d3.com”>
<input type=“hidden” name=“no_shipping” value=“2”>
<input type=“hidden” name=“no_note” value=“1”>
<input type=“hidden” name=“currency_code” value=“USD”>
<input type=“hidden” name=“bn” value=“PP-BuyNowBF”>
<input type=“image” src=“https://www.paypal.com/en_US/i/btn/x-click-
but23.gif” border=“0” name=“submit” alt=“Make payments with PayPal -
it's fast, free and secure!”>
<img alt=“” border=“0”
src=“https://www.paypal.com/en_AU/i/scr/pixel.gif” width=“1”
height=“1”>
</form>

To work, TYPE ONE Buy Buttons require additional software functions as part of the Button code. This makes them unsuitable for promotions in an offline environment.

TYPE TWO Buy Buttons use the Uniform Resource Locator (URL) to work. A URL is a string of characters conforming to a standardized format, which refers to a resource on the Internet by its location. A URL contains a domain name followed by a path and in the case of current Buy Now buttons also contains additional parameters which conform to the URL scheme. TYPE TWO buttons require the additional parameters to enable them to initiate the purchasing function for a specific product.

A TYPE TWO example is the PayPal Buy Now button for insertion in emails:

https://www.paypal.com/cgi-

bin/webscr?cmd=_xclick&business=registrations3%403d3%2ecom%no_shippin
g=2&no_note=1&currency_code=USD&bn=PP%2dBuyNowBF&charset=UTF%2d8

In this case ‘www.paypal.com’ is the domain name, ‘/cgi-bin/webscr’ is the path and everything from ‘?’ onwards are parameters, to allow a software function to add the product to a shopping cart or to a check-out process.

While a customer could manually enter the content of a TYPE TWO Button into a browsing device to initiate a purchase, the process would be unreliable due to the length of Type Two Button URLs with the parameters and would still require the steps of the domain name being extracted from the URL, the browsing device connecting to the DNS system to establish the location of the web server associated with the domain name, the web server extracting the path to connect to the web site and specifically to the web site resource defined by the path, and the web site resource extracting the parameters to retrieve product information associated with the product to add the product to an Electronic Shopping Cart, for example. Any additional step requires additional software calculations and therefore additional system resources.

However to date the complexity of TYPE TWO buttons prevent them from being promoted in the Offline World. The required parameters which make the TYPE TWO Buy Button work, make them too complex to be announced for example on TV or radio or to be reliably copied by a customer from a newspaper into a browsing device. Consequently TYPE TWO buttons are limited to being used in documents which support hyperlinks. The URL with the parameters is used as part of a hyperlink which is invisible to the customer, and is instead visually represented by an image of a Buy Now Button or some short text such as “Buy Now”. The customer must then click on the button image or the Buy Now text to initiate the purchase.

Accordingly there is a need for a Buy Now function for use in an Electronic Commerce system, method and associated apparatus, which reduces and simplifies the steps required to make an impulse purchase via the Internet for products promoted in the Offline World.

### Definitions

In this specification:
‘Goods’ is used as a generic term for products available for purchase, and includes services;
‘Customer’ is a person who wants to place an order for goods promoted in the Offline World via the Internet;
‘Product Information’ refers to data associated with goods which may allow a customer to purchase goods or a seller to identify the ordered goods. Such data could be a catalogue number, a price, a name, a domain name or any other data required by an e-Commerce System;
a ‘Browsing Device’ may be a computer, mobile phone, interactive TV or any device (including software executing on a hardware platform) which allows a customer to access the Internet;
an ‘Electronic Shopping Cart’ is a software program which emulates a shopping cart in the Offline World. It groups product information of goods a customer wants to purchase so that the customer can place an order for them via the Internet—usually by going through a check-out process—and is possibly displayed via the browsing device;
a ‘Domain Name’ is an Internet resource name maintained by the Domain Name System (DNS), having the implementation and specification defined in the Internet Standard RFC1035;
a ‘Customer Identifier’ is a physical or digital object or behaviour on the browsing device which allows the automatic identification of a specific customer. An identifier could be a cookie stored on a browsing device, the phone number of a mobile phone used as browsing device, a special hardware or software ID or configuration unique to the browsing device, a unique behavioural pattern by the browsing device or the customer or any other method which allows the automatic identification of a customer, who wants to order a product via a browsing device;
a ‘Product Identifier’ is a code, preferably being a human-readable string, and more preferably being an alphanumeric string, which may be used to uniquely identify a product available for ordering online via a web server;
a ‘Network Resource Locator’ is an identifier which includes a domain name resolvable via the DNS, and which optionally includes other components that are at least sufficient to enable a corresponding network resource to be uniquely identified and contacted via the Internet. A network resource locator is thus a specific form of Uniform Resource Identifier (URI), as defined by Internet Standard RFC 3986. The term network resource locator, as used herein, is substantially synonymous with Uniform Resource Locator (URL). Alternative nomenclature is employed in order to avoid any possible confusion with past or present “standard” definitions of the acronym URL, which is now widely considered to be an obsolescent term in view of the more comprehensive standardisation of URIs.
‘Customer Details’ are any details about a customer required by a seller or automatic system to accept or fulfil an order. Examples could be an email address, an identification code, a delivery address or payment details;
a ‘Seller’ is any person or automated device which offers goods for sale;
an ‘ordering process’ is the general process which occurs between the selection of goods by a customer and the finalisation of an order, and thus generally encompasses processes of adding goods to an order (e.g. via an electronic shopping cart), providing and/or confirming customer and payment details, providing final confirmation, and may further include the actual delivery of goods or provision of services. However, it will be appreciated that a variety of different ordering processes are conceivable, and that any or all of these steps may be omitted and/or automated in an e-commerce system;
‘recording an order for goods’ refers to a step of adding goods to an ordering process, but need not include the further steps of actually confirming, placing or completing the order; and
‘Check-Out Process’ is any customer action or software process or combination thereof which follows the selection of goods to be purchased to complete an order. A check-out process may form part of an ordering process (in accordance with the definition above), and may further include delivering the order to a seller. It should be noted, in the context of the present invention, that the selection of goods may occur in the Offline World.

### SUMMARY OF THE INVENTION

In one aspect, the present invention provides a method of ordering goods via the Internet using a browsing device, the method including the steps of:

associating the goods with a network resource locator which includes a domain name;

establishing via a DNS system, using at least one DNS server, an association between the goods and at least one web server utilising said domain name;

the browsing device issuing a DNS request to resolve said domain name, and receiving in response from the DNS system an Internet address of said at least one web server;

the browsing device requesting a connection to the web server; and

the web server executing an ordering process in response to said connection request,

wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

Accordingly, the invention provides a method whereby a customer can initiate an ordering process on the Internet, simply by entering a network resource locator into a web browser executing on a computer or other web-enabled device. Advantageously, the present invention utilises the DNS system as a mechanism for identifying a product for purchase. That is, whereas prior art methods have conventionally relied upon product information encoded in web forms and/or complex and lengthy parameters included in URLs submitted to web servers, the present invention enables the required product information to be associated with a domain name. Advantageously, it is thereby possible for a seller to advertise products or services for sale via offline media, wherein a simple and easily entered network resource locator is provided which, upon entry by a customer, may directly and automatically result in the generation of an order for purchase of the products or services.

A further advantage of using the DNS system in accordance with embodiments of the present invention, by comparison with prior art methods using URLs with parameters, is that it will allow the distribution of products even from the same seller on different servers all around the world, which can help with load balancing computer resources when many customers try to purchase the same popular products, for example. Another advantage of this approach is that using a domain name or a network resource locator can more directly connect a customer to product information stored on a server, bypassing the steps of associating the path with a web site resource and or the interpretation of the parameters associated with current “buy now” functions.

In another aspect, the present invention provides a method of a customer ordering goods via the internet using a browsing device, the method including the steps of:

the customer entering into the browsing device a network resource locator which includes a domain name;

the browsing device issuing a DNS request to resolve the domain name, whereby a DNS server provides an Internet address of a corresponding web server which is associated via a DNS system with the domain name and goods to be ordered by the customer; and

the browsing device requesting a connection to the web server, whereby the web server executes an ordering process in response to said connection request,

wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

Accordingly, in some embodiments of the invention the network resource locator includes a product identifier within a domain name. As will be appreciated, a domain name generally consists of a top-level domain (such as “.com”, “.net” or a country code top-level domain such as “.au”), optional lower-level domains, and a host-name component, concatenated in descending scope from right to left. Preferably, a product identifier is included within a domain name as a host-name component. For example, the domain name “123.santu.com” includes a product identifier code “123” associated with particular goods or services.

In accordance with a preferred embodiment, the step of establishing an association between the goods and the web server includes utilising a wildcard approach, wherein any network resource locator including a specified domain name component is subsequently resolved by the DNS system to an address of the web server independently at least of the product identifier included within the host name component, and wherein the product identifier is resolved by the web server. Advantageously, this avoids the need to configure the DNS system to include records corresponding with each individual product identifier, but rather allows the product identifiers to be resolved by the target web server. In specific embodiments, for example, any sub-domain of the specified domain, including any host-name within the domain, would accordingly be resolved to the same web server. The association of the host-name or sub-domain component with the goods may then take place on the web server, whereby advantageously the addition, deletion and/or modification of product identifiers may be performed locally at the web server, without the need to reconfigure the DNS system.

In alternative embodiments, the network resource locator includes the product identifier within a distinct component thereof. For example, the product identifier may be included as a component of a path appended to a domain name within the network resource locator, such as “www.santu.com/123”. Alternatively, the product identifier may be included within the network resource locator as a parameter component appended to a domain name, such as “www.santu.com?123”. In either of the foregoing examples, the code “123” is a product identifier associated with corresponding goods and/or services.

In a preferred embodiment, the web server may retrieve product information of the goods associated with the network resource locator, for example from a relevant product database, in order to obtain the information necessary to perform the ordering process.

In some implementations, the web server may combine product information with an electronic shopping cart of the customer, thereby enabling the customer to add further goods to an order before completing a purchase. Alternatively, product information may be included directly in the electronic check-out process. This latter approach may be most suitable when it is likely that the customer will only make a single purchase. By eliminating the intermediate shopping cart stage, the number of steps required to be executed by the consumer is further reduced. In principle, an entire transaction may be completed simply through the entry by the customer of a domain name into a browsing device. Accordingly, in appropriate circumstances the present invention may provide for a “no click” online purchasing process.

A check-out process, with or without the use of an electronic shopping cart, may take different forms, depending on the relationship of the customer with the web site and the type of goods offered. For example, the customer may be required to provide customer details, before the purchase may be completed.

Alternatively, if a customer identifier is present on, or associated with, the customer's browsing device, the web server may create the order automatically by retrieving the identifier and combining the product information associated with the domain name with the customer details associated with the customer identifier, without any further interaction required from the customer.

The web server may, even though a customer identifier could allow the automatic generation of an order, simply request an interaction from the customer, such as clicking on a button, to confirm the decision to place the order, for example.

In some embodiments, goods may be offered or promoted for sale by a reseller, who is for example an agent, retailer or distributor for an original producer and/or seller of the goods. In such embodiments, the network resource locator preferably includes a reseller identifier, for example within the domain name, which enables the reseller to be uniquely identified. The ability to identify the reseller advantageously enables the payment of a commission to the reseller.

In another aspect, the present invention provides a system for enabling a customer to order goods via the Internet using a browsing device, the system including:

at least one web server; and

at least one DNS server in a DNS system, wherein the DNS server is configured to establish an association between said goods, at least one corresponding domain name, and said web server, whereby a request issued to said DNS server to resolve said corresponding domain name results in a response providing an Internet address of said web server,

wherein the web server is configured to respond to a connection request initiated using said Internet address and a corresponding network resource locator including said domain name, by executing an ordering process, and

wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

In still another aspect, the present invention provides an e-commerce web server for enabling goods to be ordered via the internet using a browsing device, the web server including:

at least one processor;

a network interface operatively connected to said processor and to the Internet; and

at least one storage medium operatively coupled to the processor, the storage medium containing program instructions for execution by the processor, said program instructions causing the processor to effect the steps of:
receiving via the network interface a connection request from a browsing device, wherein said connection request corresponds with a network resource locator which includes a domain name resolved to an Internet address of the web server via a DNS system which includes at least one DNS server configured to establish an association between said domain name and the web server; and
executing an ordering process in response to said connection request,

wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

Further benefits and advantages of the present invention will become apparent in the following description of preferred embodiments of the invention, which should not, however, be considered to limit the scope of the invention as set out in any of the preceding statements, or any claims appended hereto.

### BRIEF DESCRIPTIONS OF THE DRAWINGS

The preferred embodiment is described with reference to the accompanying drawings in which like numerals represent like elements, and in which:

FIG. 1 is a diagram illustrating schematically an embodiment of a system and method according to the invention, in which a domain name is used to promote a product in the Offline World and a customer purchases the product via the Internet;

FIG. 2 is a diagram illustrating schematically an embodiment of a system and method according to the invention, in which a domain name is used to promote a product in the Offline World and a customer purchases the product via the Internet, and in which the customer is a registered customer, which allows the system to automatically process the order and deliver the goods ordered;

FIG. 3 illustrates schematically a web server configured in accordance with an embodiment of the present invention; and

FIG. 4 is a flowchart summarising a method of ordering goods via the Internet in accordance with preferred embodiments of the invention.

### DESCRIPTION OF PREFERRED EMBODIMENTS

In preferred embodiments of the invention an automated procedure is provided to enable a customer to add a specific product or service to an Electronic Shopping Cart on the Internet, or to make an immediate purchase, simply by entering a domain name into a browsing device.

According to one preferred embodiment, the customer enters a domain name into a browsing device and a DNS system directs the browsing device to a computer containing product information which is associated with the domain name, such as a product name and price. A software function then combines product information with the required programming functions to add the product to an Electronic Shopping Cart without further intervention by the customer.

The automatic procedure of adding the product to the shopping cart based on a domain name simplifies the purchasing process for the customer, who can initiate the purchase of a product simply by entering a domain name, without the need to navigate a web site to find a product and without the requirement to click on a button to add the product to the shopping cart. Differing levels of automation may be provided, to make the ordering process even easier. For example when the customer wants to buy only a single item, the Electronic Shopping Cart can be bypassed. The software can then immediately combine the product information with an electronic check-out process.

It should furthermore be understood that the customer may be identified by the use of a Customer Identifier such as a data cookie stored on the customer's computer or mobile phone, and that therefore even the check-out process can be completed automatically and without any further customer interaction.

Advantageously, once an order has been generated and delivered it will also be possible to immediately deliver digital goods such as MP3 files, software programs or an access service without any further human interaction, and that therefore a customer may, by simply entering a domain name, complete the ordering process as well as immediately receive the product or service ordered.

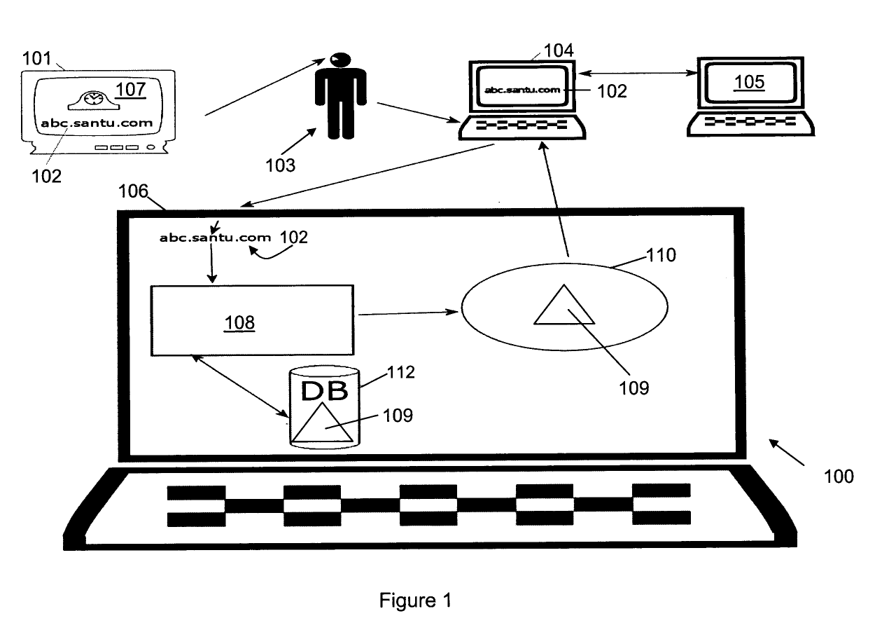

In a first embodiment 100, illustrated in FIG. 1, a network resource locator consisting of the domain name 102 (“abc.santu.com”) is displayed on a TV 101 as part of a promotion for a product 107.

A customer 103 sees the domain name 102 on the TV and inputs it in a browsing device 104.

The browsing device 104 makes a request to a DNS name server 105 via the Internet, in a conventional manner.

In accordance with the invention, the DNS name server 105 has been configured so as to establish an association between the promoted product 107, the corresponding domain name 102, and a web server 106. In particular, according to preferred embodiments the DNS server 105 is configured to respond to a request for resolution of the domain name 102 by providing an Internet address of the web server 106. Since the domain name 102 is associated with the product 107, there is thereby established within the DNS system an association between the product 107, the domain name 102, and the web server 106. As will be appreciated, the DNS system is distributed across the Internet, and accordingly there may ultimately be more than one DNS server, eg 105, within which the association is established. Advantageously, it may thereby be possible to create associations in different geographical regions, to which service is provided by different DNS servers, between the product 107 and a number of different web servers. This feature may be utilised to provide a more efficient distribution network, and/or to implement load-sharing for e-commerce transactions across the Internet.

The DNS name server 105 identifies the web server 106 which is associated with the domain name 102 and returns the result to the browsing device 104 to connect the browsing device 104 with the web server 106.

The web server 106 receives the domain name request from the browsing device 104 and redirects the request to a software function 108 which executes on the server 106. The software function 108 uses the domain name 102 requested by the browsing device 104 to retrieve product information 109 for the product 107 associated with the domain name 102 from a database 112.

In accordance with a preferred embodiment, the DNS name server 105 is configured in accordance with a wildcard approach. Advantageously, the wildcard approach enables any sub-domain within the domain name 102 to be associated with a single web server 106. As a result, any specified domain name 102 matching a similarly specified wildcard rule will resolve to the address of the web server 106, independently of the sub-domain component, including any host-name component. Thus the sub-domain and/or host-name may be resolved by the web server 106, rather than by the DNS server 105. That is, association of goods with a product identifier contained within the sub-domain name and/or host name takes place on the web server 106. Accordingly, changes such as the addition, deletion or modification of product identifiers may be implemented locally at the web server 106, and the need to configure the DNS name server 105 with all relevant product identifiers, and to reconfigure the DNS name server 105 upon any change, may be avoided.

The software function 108 then adds the product information 109 to a shopping cart 110 and displays the shopping cart 110 to the customer 103 via the browsing device 104 to allow the customer 103 to complete the purchase.

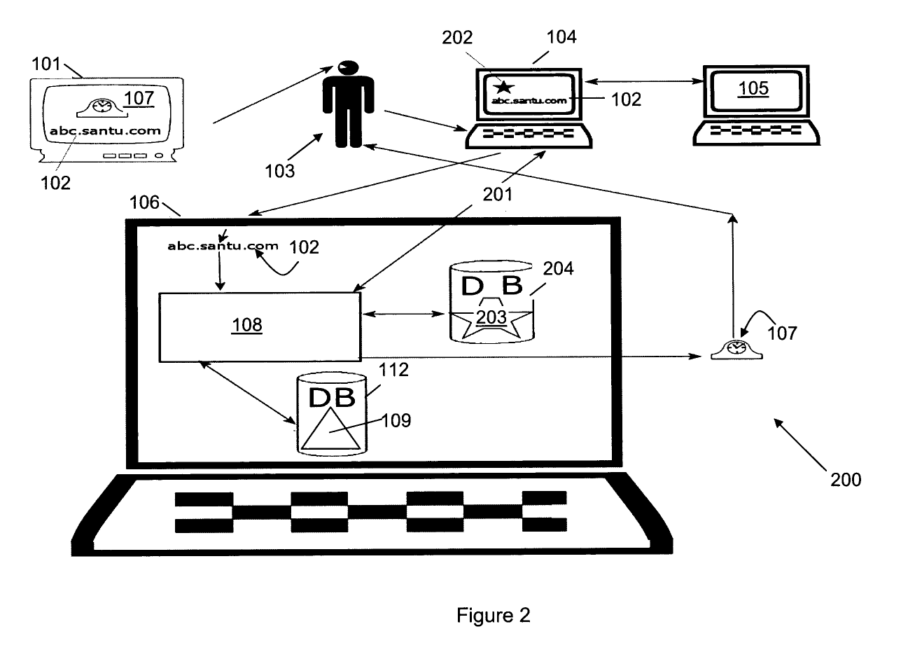

In a second embodiment 200, illustrated in FIG. 2, the software function 108 sends a query 201 to the browsing device 104 to look for a customer identifier such as a cookie 202 stored on the browsing device 104 to establish if the customer 103 is a registered customer, and, if it finds the cookie 202, uses the cookie 202 to establish the relevant customer details 203 of the customer 103, such as payment and address details, by querying a customer database 204, and then uses the customer details 203 to automatically process the order, and to initiate the delivery of the product 107 to the customer 103 without any interaction required on the part of the customer 103.

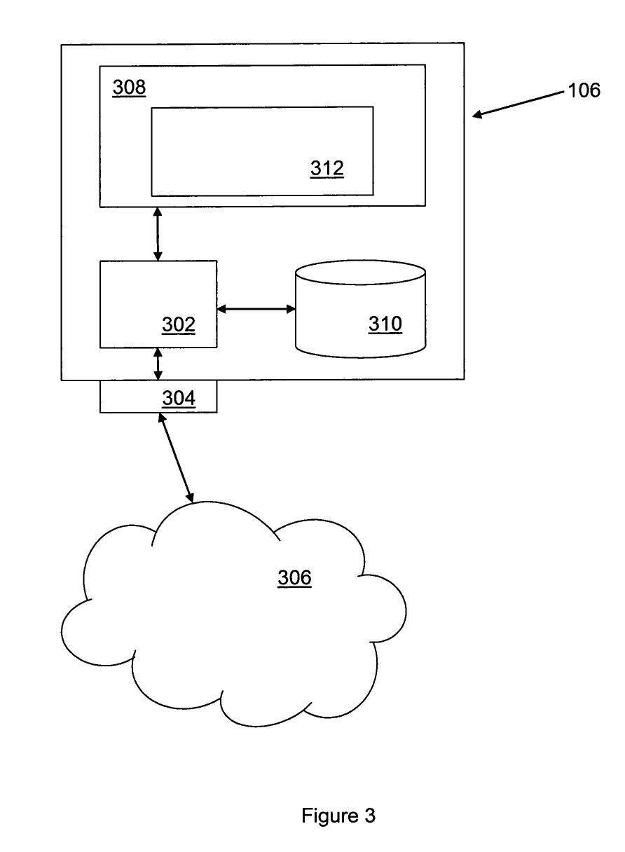

The web server 106 may be implemented as one or more computer systems conforming generally to the exemplary system illustrated schematically in FIG. 3. Relevantly, the web server 106 includes at least one processor 302, and a network interface 304 operatively connected to the processor in order to provide connectivity to the Internet 306. Furthermore, the web server 106 includes at least one storage medium, such as solid state random access or read only memories 308, and/or one or more mass storage devices 310 such as hard-disk drives, which are operatively coupled to the processor. The storage medium, or media, may then contain program instructions 312 for execution by the processor, and in particular implementing the aforementioned functionality of the web server 106, including the software function 108 which utilises the domain name 102 to retrieve product information 109, and execute the steps of an appropriate ordering process. The one or more storage media 308, 310 may also be used to maintain the database 112, and state information such as one or more user shopping carts, including the shopping cart 110.

As will be understood from the foregoing, in various embodiments of the invention the web server 106 may execute an ordering process in response to a connection request from browsing device 104 either by proceeding to a check-out process prior to the final placement of an order, or by proceeding directly and automatically to the final placement of an order, initiated by the entry of a network resource locator including a product identifier within a domain name component thereof. In particular, as depicted in FIGS. 1 and 2, the network resource locator 102 consists solely of the domain name “abc.santu.com”. Within the domain name 102 the host name component “abc” acts as a product identifier, uniquely identifying the goods or services to be ordered by the customer 103 via the web server 106. As noted above, in preferred embodiments the DNS name server 105 may be configured in accordance with a wildcard approach such that, for example, all network resource locators 102 matching the high-level domain name “santu.com” are resolved to the address of a single web server 106. Accordingly, the product identifier, eg “abc”, may be processed and/or resolved by the web server 106, rather than within the DNS system. Other strings, being preferably human-readable, and more preferably alphanumeric, may be used within the systems 100, 200 to identify different products.

According to further alternative embodiments the promoted network resource locator may include a product identifier within a separate component thereof. For example, a single domain name, such as “www.santu.com” may be utilised in combination with a product identifier provided in a path component or parameter component appended to the domain name. For example, the network resource locator “www.santu.com/123” includes the product identifier “123” as a local path component. As an alternative, the network resource locator “www.santu.com?123” includes the same product identifier as a parameter component. Such local path and/or parameter components may be received and parsed by the web server in order to extract the product identifier, in order to identify the corresponding goods to be ordered by the customer 103.

In particular, embodiments of the invention may broadly be classified into two types. According to a first class of embodiments, the network resource locator includes a product identifier within the domain name (eg “123.santu.com”) all within a distinct component of the network resource locator (eg “www.santu.com/123” or “www.santu.com?123”), and an ordering process is executed which proceeds directly and automatically to the final placement of an order, for example as described above with reference to FIG. 2.

According to a second class of embodiments the network resource locator includes a product identifier specifically within the domain name only (eg “123.santu.com”), and an ordering process is executed which includes a check-out process prior to the final placement of an order, for example as described above with reference to FIG. 1.

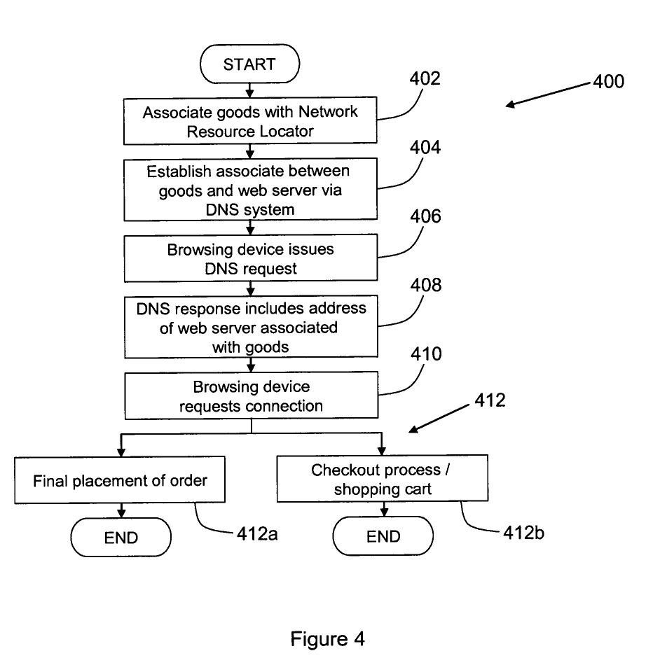

FIG. 4 is a flowchart 400 summarising a method of ordering goods via the Internet in accordance with the various embodiments described above. At step 402 an association is created between the goods to be made available for purchase via the Internet, and a network resource locator which includes a domain name. At step 404 an association is then established between said goods and at least one web server (eg web server 106) via a DNS system, and using at least one DNS server (eg DNS name server 105), utilising the domain name. At step 406 a user operates a browsing device, entering the domain name associated with the goods, resulting in a DNS request being issued in order to resolve the domain name. A response is received from the DNS system at step 408, including an Internet address of the associated web server. The browsing device then requests a connection to the web server, at step 410, subsequent to which an ordering process 412 is executed. In accordance with the aforementioned first class of embodiments, the ordering process proceeds directly at step 412a to the final placement of an order, whereas in accordance with the second class of embodiments an ordering process 412b is executed which proceeds via a check-out process prior the final placement of an order.

As will be appreciated, embodiments of the invention falling within either of the two broad classes described above similarly provide the advantage of enabling a simple and concise network resource locator to be provided, which is readily entered by a user directly into a browsing device, followed by differing degrees of functionality within the subsequently executed ordering process. The selection of differing embodiments of the invention may be based, for example, upon the availability or otherwise of suitable customer information to a web server 106 in order to facilitate completion of an order, and/or a desired format of the network resource locator used by the customer to initiate the process. Indeed, a single web server 106 may be programmed with appropriate functionality to implement either class of embodiment of the invention, in accordance with the available customer information and the format of the network resource locator entered by the customer to initiate an ordering process.

It is envisaged that goods may be offered or promoted for sale, for example in different markets, by one or more resellers acting as agents, retailers and/or distributors for the original producer and/or seller of the goods. For example, a reseller operating within a particular geographical market may be authorised to promote and sell specified goods and/or services on behalf of an original supplier. It may be, however, undesirable, for example for reasons of cost or efficiency, for each such reseller to operate their own online commerce system. Instead, a single centralised or distributed system may be provided, in accordance with an embodiment of the present invention, for the processing and completion of all online sales. In this case, it is nonetheless desirable to enable the reseller responsible for promoting the goods to a particular customer, leading to a corresponding sale, to be rewarded for their efforts in this regard, for example through the payment of a commission.

To this end, goods may be promoted for sale by a reseller using a network resource locator which includes a reseller identifier, for example within the domain name, which enables the reseller associated with the network resource locator to be uniquely identified. For example, a reseller identifier may be included within the domain name component of the network resource locator. In such embodiments, it will be appreciated that various network resource locators may exist which are associated with the same goods, but with different resellers. A customer using a network resource locator obtained as a result of the promotional efforts of a particular reseller will accordingly identify not only the goods to be purchased, but also the reseller whose promotional efforts have resulted in the sale. The ability to identify the reseller in this manner advantageously enables the subsequent payment of a commission to the reseller.

It will be understood that the scope of the present invention is not limited to the embodiments described herein, which are exemplary only. Numerous variations will be apparent to those skilled in the art, within the scope of the invention as defined by the appended claims.

According to some variations of the invention, the process of selecting goods and the check-out process may be spread across multiple servers in different locations, so that for example a first server may identify a product based on the domain name or network resource locator, but the product information, customer details, shopping cart software, check-out process, or software delivery may be spread across one or more other servers.

Software programs and functions required for the methods described may be executed on a computer acting as a server (ie a “server-side” implementation), or alternatively software programs and functions as well as product information could be served to the customer's browsing device via the Internet, so that a domain name or network resource locator could be associated with product information on the customer's browsing device for example (ie a “client-side” implementation). It would therefore also be possible to combine the product information with the Electronic Shopping Cart or to complete the check-out process, either on the server side or the client side.

It is furthermore understood that those skilled in the art could use different software functions and different data storage methods and different ways to initiate the software functions or to retrieve product data or to access customer identifiers on the browsing device and could initiate the software functions and access the data at different stages to those described in this specification to achieve substantially the same result.

Since it is also possible to detect if network resource locations have been entered by a user directly into a browsing device, or have been activated from web pages, for example as hyperlinks, it is therefore possible to initiate different behaviours on a web server, depending on the result of such a detection. Accordingly, a single web server may be used to place orders using the method of the present invention, as well as using conventional techniques based in web links, such as “Buy Now” buttons.

Those skilled in the art will also understand that depending on the browsing device used a customer may have to use different input devices to enter a domain name, and that these input devices could include but are not limited to a physical or software keyboard, a stylus or other writing device, a touch screen or a microphone.

1. A method of ordering goods via the Internet using a browsing device, the method including the steps of:
associating the goods with a network resource locator which includes a domain name;
establishing via a DNS system, using at least one DNS server, an association between the goods and at least one web server utilising said domain name;
the browsing device issuing a DNS request to resolve said domain name, and receiving in response from the DNS system an Internet address of said at least one web server;
the browsing device requesting a connection to the web server; and
the web server executing an ordering process in response to said connection request, wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

2. The method of claim 1 wherein the network resource locator includes a product identifier within a domain name, the product identifier being included within the domain name as a host-name component.

3. The method of claim 2 wherein the step of establishing an association between the goods and the web server includes utilising a wildcard approach, wherein any network resource locator including a specified domain name component is subsequently resolved by the DNS system to an address of the web server independently at least of the product identifier included within the host-name component, and wherein the product identifier is resolved by the web server.

4. The method of claim 1 wherein the network resource locator includes a product identifier within a distinct component thereof, the product identifier being included as a component of a path appended to the domain name within the network resource locator.

5. The method of claim 1 wherein the network resource locator includes a product identifier within a distinct component thereof, the product identifier being included as a parameter component appended to the domain name within the network resource locator.

6. The method of claim 1 comprising the step of the web server retrieving product information of the goods associated with the network resource locator in order to obtain the information necessary to perform the ordering process.

7. The method of claim 1 further including the step of the web server combining product information with an electronic shopping cart of the customer, thereby enabling the customer to add further goods to an order before completing a purchase.

8. The method of claim 1 including a check-out process wherein product information is included directly in said check-out process.

9. The method of claim 1 comprising the step of the customer providing customer details prior to completion of a purchase.

10. The method of claim 1 wherein a customer identifier is present on, or associated with, the browsing device, and further including the step of the web server automatically creating an order by retrieving the customer identifier and combining the product information associated with the domain name with customer details associated with the customer identifier.

11. The method of claim 10 further including the step of the web server requesting an interaction from the customer via the browsing device, in order to confirm a decision to place an order.

12. The method of claim 1 wherein goods are offered or promoted for sale by a reseller, and wherein the network resource locator includes a reseller identifier which enables the reseller to be uniquely identified.

13. The method of claim 12 further including the step of paying a commission to the reseller.

14. A system for enabling a customer to order goods via the Internet using a browsing device, the system including:
at least one web server; and
at least one DNS server in a DNS system, wherein the DNS server is configured to establish an association between said goods, at least one corresponding domain name, and said web server, whereby a request issued to said DNS server to resolve said corresponding domain name results in a response providing an Internet address of said web server,
wherein the web server is configured to respond to a connection request initiated using said Internet address and a corresponding network resource locator including said domain name, by executing an ordering process, and
wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

15. The system of claim 14 wherein the network resource locator includes a product identifier within a domain name, the product identifier being included within the domain name as a host-name component.

16. The system of claim 15 wherein the DNS server is configured according to a wildcard approach, wherein any network resource locator including a specific domain name component is subsequently resolved by the DNS system to an address of the web server independently at least of the product identifier included within the host-name component, and wherein the web server is further configured to resolve the product identifier.

17. The system of claim 14 wherein the network resource locator includes a product identifier within a distinct component thereof, the product identifier being included as a component of a path appended to the domain name within the network resource locator, and wherein the web server is further configured to resolve the product identifier within said path component.

18. The system of claim 14 wherein the network resource locator includes a product identifier within a distinct component thereof, the product identifier being included as a parameter component appended to the domain name within the network resource locator, and wherein the web server is further configured to resolve the product identifier within said parameter component.

19. The system of claim 14 wherein goods are offered or promoted for sale by a reseller, and wherein the network resource locator includes a reseller identifier which enables the reseller to be uniquely identified.

20. The system of claim 19 wherein the web server is further configured to record the reseller identifier, to enable subsequent payment of a commission to the reseller.

21. An e-commerce web server for enabling goods to be ordered via the internet using a browsing device, the web server including:
at least one processor;
a network interface operatively connected to said processor and to the Internet; and
at least one storage medium operatively coupled to the processor, the storage medium containing program instructions for execution by the processor, said program instructions causing the processor to effect the steps of:
receiving via the network interface a connection request from a browsing device, wherein said connection request corresponds with a network resource locator which includes a domain name resolved to an Internet address of the web server via a DNS system which includes at least one DNS server configured to establish an association between said domain name and the web server; and
executing an ordering process in response to said connection request,
wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.

22. The e-commerce web server of claim 21 wherein the network resource locator includes a product identifier within a domain name, the product identifier being included within the domain name as a host-name component, the DNS system being configured in accordance with a wildcard approach whereby any network resource locator including a specified domain name component is subsequently resolved by the DNS system to an address of the web server independently at least of the product identifier included within the host-name component, and wherein the program instructions further cause the processor to effect the step of resolving the product identifier within the host-name component.

23. The e-commerce web server of claim 21 wherein the network resource locator includes a product identifier within a distinct component thereof, the product identifier being included as a component of a path appended to the domain name within the network resource locator, or as a parameter component appended to the domain name within the network resource locator, and wherein the program instructions further cause the processor to effect the step of resolving the product identifier within said component of the network resource locator.

24. The e-commerce web server of claim 21 wherein goods are offered or promoted for sale by a reseller uniquely identified by a reseller identifier, wherein the network resource locator includes said reseller identifier, and wherein the program instructions further cause the processor to effect the step of recording the reseller identifier to enable the subsequent payment of a commission to the reseller.

25. A method of a customer ordering goods via the internet using a browsing device, the method including the steps of:
the customer entering into the browsing device a network resource locator which includes a domain name;
the browsing device issuing a DNS request to resolve the domain name, whereby a DNS server provides an Internet address of a corresponding web server which is associated via a DNS system with the domain name and goods to be ordered by the customer; and
the browsing device requesting a connection to the web server, whereby the web server executes an ordering process in response to said connection request,
wherein the network resource locator and the ordering process are selected from the group consisting of:
a network resource locator which includes a product identifier within the domain name or within a distinct component of the network resource locator, and an ordering process which proceeds directly and automatically to the final placement of an order; and
a network resource locator which includes a product identifier within the domain name only, and an ordering process which includes a check-out process prior to the final placement of an order.
